(19) United States
(12) Patent Application Publication
(10) Pub. No.: US 2004/0184270 A1
(43) Pub. Date: Sep. 23, 2004

(54) LED light module with micro-reflector cavities

(76) Inventor: Michael A. Halter, Conway, AR (US)

Correspondence Address: J. Charles Dougherty, Wright, Lindsey & Jennings LLP, Suite 2300, 200 West Capitol Avenue, Little Rock, AR, 72201, US

(21) Appl. No.: 10/802,167

(22) Filed: Mar. 17, 2004

Related U.S. Application Data
(60) Provisional application No. 60/455,269, filed on Mar. 17, 2003.
(60) Provisional application No. 60/455,129, filed on Mar. 17, 2003.
(60) Provisional application No. 60/455,126, filed on Mar. 17, 2003.
(60) Provisional application No. 60/455,127, filed on Mar. 17, 2003.

(51) Int. Cl. F21V 7/00

(52) U.S. Cl. 362/296

(57) ABSTRACT

A silicon wafer with micro-reflector cavities for mounting LED dies is disclosed. The cavities are formed by means of anisotropic etching. The cavities may be lined with a metallic material with good electrical conducting properties. The cavity and LED die may be capped with an encapsulant material to further focus the LED light. The wafer is particularly well-suited for the placement of RGB LED dies in clusters for efficient LED illumination.

### CROSS-REFERENCE TO RELATED APPLICATIONS

The present application claims the benefit of U.S. provisional patent applications Ser. No. 60/455,269, entitled “Spectrally Calibratable Multi-Element RGB LED Light Source”; 60/455,129, entitled “Indirect Lighting System Architecture and Implementation”; 60/455,126, entitled “Anisotropic Etching of Silicon Wafer Materials to Create Micro-Reflector Cavities for LED Die”; and 60/455,127, entitled “Micro-Strip-Line Signal and Power Buss Flexible Cable and Method of Using Same,” each of which was filed on Mar. 17, 2003, and for each of which the inventor is Michael A. Halter. The present application is further related to the three co-pending applications filed on even date herewith entitled “Indirect Lighting System Architecture and Implementation,” “Spectrally Calibratable Multi-Element RGB LED Light Source”, and “Micro-Strip-Line Signal and Power Bus Flexible Cable and Method of Using Same,” the inventor for each of which is Michael A. Halter. The entire disclosure of each of the foregoing provisional and non-provisional applications are incorporated herein by reference.

### BACKGROUND OF THE INVENTION

The present invention relates to lighting modules comprising light emitting diodes (LEDs), and in particular to such modules comprising micro-reflector cavities to improve the illumination efficiency of such lighting modules.

LEDs are semiconductors that convert electrical energy into light. Since LEDs generate relatively little heat compared to other common forms of lighting, such as incandescent lights, the energy conversion process performed by LEDs is quite efficient. This is a highly desirable trait in lighting systems to be used for illumination, since excessive heat production not only wastes electricity, but may also require extensive heat dissipation efforts, and may even raise safety concerns depending upon the fixture installation. Some of the other advantages that make LEDs desirable for illumination applications include their small size; their relatively high radiance (that is, they emit a large quantity of light per unit area); their very long life, leading to increased reliability; and their capacity to be switched (that is, turned on and off) at very high speeds.

While visible light LEDs have been applied in a number of fields since their invention in 1960, they have been used for illumination applications only relatively recently. One of the primary limitations in the use of LEDs in this field has been the difficulty of producing white light. White light consists of a mixture of light wavelengths across the visible light spectrum. Traditional LEDs cannot produce white light; instead, each LED can produce only light in one very narrow frequency band. It is well known that the combination of light in the three primary colors of red, green, and blue will produce white light. In fact, any color of light may be produced by the appropriate combination of light in these three colors. While red and green LEDs have been commercially available for decades, the blue LED was not developed until 1993, when it was introduced by the Nichia Corporation of Japan. By combining these traditional red, green, and blue LEDs in a tightly coupled pattern, a crude form of white light could then be produced. By varying the relative intensity of the light emitted by the red, green, and blue LEDs, one could alter the color of light produced, thereby providing a light source that will generate light of any color desired.

An alternative method of producing white light, developed by the Nichia Corporation in 1996, is the coating of a blue LED with a white phosphor. The blue LED stimulates the phosphor to generate a broad band of visible light emissions, thereby producing white light. This method suffers from the limitation that the frequency band of light produced is fixed, and cannot be altered to produce different lighting effects from the same LED. This method is therefore inappropriate for applications where different colors of light or lighting effects may be desired.

In addition to the problem with producing white light, the other primary limitation on the use of LEDs for illumination applications has been their brightness, which historically was far below that of typical incandescent and fluorescent light sources. By 1997, however, the Nichia Corporation, along with Texas Instruments Incorporated of Dallas, Tex., were producing LEDs of sufficient brightness for many illumination applications. It thus became possible to provide complete illumination solutions using only LEDs in certain applications, such as relatively small, indoor areas.

As already explained, a very simple system for producing white light with LEDs could involve the application of a pre-set current to a combination of red, green, and blue LEDs. It would be possible with such a system to emulate, for example, the color of light produced by daylight or by a typical incandescent bulb. Such a simple system would not, however, allow the user to take advantage of the many opportunities for temperature variance made possible by the use of an LED illumination system. (It should be noted that light color is often referred to as its “color temperature” or simply “temperature,” corresponding to the temperature of a black body that would produce light of that color measured in degrees Kelvin.) Since both temperature and intensity of the light produced by an LED illumination system may be varied simply by varying the amount of electrical current applied to the red, green, and blue LEDs in the system, many desirable illumination effects become possible that would not be available with incandescent lights. For example, an illumination system might include settings to emulate ambient lighting conditions at different times of day. Or the system might allow for variance in the light temperature depending upon application, such as applying a “cold” blue-tinged light for reading purposes, while allowing a “warm” red-tinged light setting to be chosen at meal times. Far more subtle and complex effects are possible. In order to take advantage of such flexibility offered by an LED illumination system, however, some form of electronic control system is required.

The mixing of red, green, and blue LED lights to produce lighting effects is known. For example, U.S. Pat. No. 5,420,482, issued to Phares, teaches a controlled lighting system that includes a set of light elements each having a control unit. The control units are individually addressable along a data bus. Information packets may be sent to each control unit by addressing each packet to match the address of the control unit. The data packets may contain information necessary to manipulate the output level of each of the light elements controlled by a particular control unit. In this way, the temperature and intensity of the light produced by each of the light elements may be manipulated by the use of digital information packets sent along a control bus. The system can thus produce an overall light output of varying temperature and intensity in response to digital signal inputs.

U.S. Pat. No. 6,016,038, issued to Mueller et al. and assigned to Color Kinetics, Inc. of Boston, Mass., teaches a method of controlling the intensity and temperature of an RGB LED system using pulse-width modulated (PWM) signals generated by a microcontroller. PWM is a well-known technique for controlling analog circuits with the output of a microprocessor or other digital signal source. A PWM signal is a square wave modulated to encode a specific analog signal level. In other words, the PWM signal is fixed frequency with varying width. The PWM signal is still a digital signal because, at any given instant of time, the full direct current (DC) supply current is either in the “on” or “off” state. The voltage or current source is thus supplied to the analog load by means of a repeating series of on and off pulses. The on-time is the time during which the DC supply is applied to the load, and the off-time is the period during which that supply is switched off. Given a sufficient bandwidth, PWM can be used to encode any analog value.

When the power to an LED is rapidly switched on and off, variance of the length of time during the on and off modes gives the effect of variance of the intensity of the light that is produced. As a result, a PWM signal can be used in place of a varying DC current to achieve intensity variance in an LED. PWM has numerous advantages over traditional analog control systems, including less heat production than analog circuits of similar precision, and significantly reduced noise sensitivity. Given the significant advantages that PWM control offers in communications and control systems applications, many microprocessors and microcontrollers produced today include built-in PWM signal generation units that may be directly applied to illumination control systems.

Another problem with prior attempts to use LEDs for illumination applications is the development of appropriate reflectors to efficiently direct or focus the LED light on the desired area. Traditional indicator or “bulb” LEDs are formed of a small LED semiconductor chip mounted in a reflector cup. The cup and LED chip are entirely encased in epoxy, which also serves as the lens of the device. Electrical leads pass from the cup through the epoxy and out of the base of the device. While sufficient for instrumentation purposes, this arrangement is not feasible for illumination applications, however, due to the high power and heat dissipation requirements necessary to generate sufficient light intensity for illumination. Typical indicator LEDs are limited to operating temperatures no greater than 120° Fahrenheit, and input power no greater than 100 milliWatts.

Recent improvements in LED design have led to significant advances in power capacity over indicator LEDs. For example, Lumileds of San Jose, Calif. now produces LED lights composed of a large LED semiconductor die mounted on a heat-sink sub-mount formed of copper or aluminum. The LED semiconductor is encased in a soft gel, which is capped with a clear lens formed of a high-temperature plastic material. These types of LEDs are capable of handling input power levels in excess of 1 Watt.

A limitation on these new high-power LED die designs, however, is that much of the light emitted from the LEDs is either lost or not directed in the desired direction. Although light intensity of LED sources has greatly improved, it still lags behind traditional sources, and the available light output must be maximized in order to provide sufficient light for many practical illumination applications. When an LED is forward biased, a percentage of the injected carriers that recombine in the vicinity of the P-N junction in the device result in the generation of photons. Because of power loss mechanisms such as absorption, Fresnel losses, and internal reflection, not all of the generated light is able to emerge from the interior of the LED semiconductor. In order to create a highly efficient LED based lighting system, all of these power loss mechanisms must be minimized.

What is desired then is a means of mounting an LED die that maximizes its efficiency by directing its light in a manner optimized for illumination applications. In addition, it would be desirable that such a mounting means be capable of dissipating the heat produced by such devices in an efficient manner so that performance of the LED is not effected by excessive heat build-up. Finally, it would be desirable to develop such an LED mounting means that could be cost-effectively manufactured.

As will be explained hereafter, the present invention utilizes anisotropic wet etching techniques in silicon wafers to overcome the limitations of prior art LED die mounting and reflecting means. The basic principles of wet chemical anisotropic etching of silicon are well known in the art. This technology is one of the most popular methods of constructing microelectromechanical systems (MEMS), sometimes referred to as “nano-technology.” MEMS are, in essence, mechanical devices that are constructed on a scale similar to that of traditional solid state electronic components. MEMS devices available today include accelerometers, chemical and biological sensors, and microfluidic devices such as valves and pumps. To the inventor's knowledge, however, the wet-etching technique has not been utilized in the formation of LED die submounts, and the potential advantages in doing so have remained unrealized. The present invention overcomes the limitations of the prior art and achieves the objectives set forth herein as described below.

### BRIEF SUMMARY OF THE INVENTION

The invention is directed to a method and apparatus that utilizes anisotropic wet etching techniques to create micro-reflector cavity systems within silicon wafer materials to optimize the optical as well as thermal efficiencies of high-power LED dies. The mounting of an LED die into a package serves to protect it from a potentially hostile environment; the inventor hereof has recognized, however, that the LED die package can also be used to increase the useful power output of the LED device by compensating for the above-mentioned power losses. In particular, as photons travel outward through the LED chip from the junction region there is a probability that absorption will take place. The longer the travel distance traversed by the light photons, the greater the internal absorption that will occur. This is the reason that smaller LED devices exhibit the highest power conversion efficiencies.

In addition, since the P-N junction on an LED semiconductor extends to and is exposed at the four sides of the chip, a large percentage of the total light output is emitted from these sides. By mounting the LED chip in a contoured cavity, the present invention allows the collection of a larger percentage of this side emitted light and reflects it upwards. In addition, in order to maximize the thermal properties of the LED dies, the preferred embodiment of the present invention comprises the thermal bonding of the LED dies within the micro-reflector cavities, with the walls of the cavities acting as reflectors for the light being emitted from the sides of the LED die. Light emitted from the sides of the LEDs is reflected off the walls of the cavities in a direction normal to the surface of the silicon wafer. The result of this design is that optical and thermal properties of the LED device are optimized by utilizing only a single component, namely, a silicon wafer material substrate. This LED device can be incorporated into various illumination applications, such as the preferred embodiment which utilizes a collection of RGB LED dies on a silicon wafer substrate to provide an illumination system with dynamically configurable light temperature and intensity settings.

The inventor has recognized that wet etching of silicon provides an ideal method of generating an LED device substrate containing all of the desired properties outlined above. The invention herein takes advantage of the anisotropic etching characteristics inherent to silicon in order to achieve these desired properties in a commercially feasible device. These and other features, objects and advantages of the present invention will become better understood from a consideration of the following detailed description of the preferred embodiments and appended claims in conjunction with the drawings as described following.

### BRIEF DESCRIPTION OF THE SEVERAL VIEWS OF THE DRAWINGS

FIG. 1 is an illustration of the distinctions between anisotropic and isotropic wet etching results on a silicon substrate.

FIG. 2 is a cross-sectional view of an LED die mounted within a micro-reflector cavity according to a preferred embodiment of the present invention.

FIG. 3A is a top view of an etched silicon wafer with micro-reflector cavities according to a preferred embodiment of the present invention.

FIG. 3B is a cross-sectional view of an etched silicon wafer with micro-reflector cavities according to a preferred embodiment of the present invention, drawn across line A-A in FIG. 3A.

FIG. 4 is a cross-sectional view of an etched silicon wafer with micro-reflector cavities with an LED die and encapsulant according to a preferred embodiment of the present invention.

### DETAILED DESCRIPTION OF THE PREFERRED EMBODIMENTS

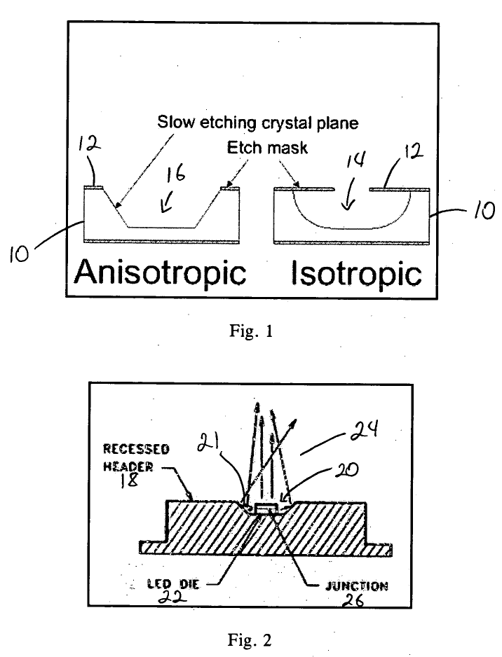

With references to FIGS. 1-2, a preferred embodiment of the present invention may now be described.

Etching may generally be defined as a process whereby a portion of a material is eaten away by the application of a chemical. The first step in etching is to place a plate or mask over the material to be etched. The mask contains openings corresponding to the areas that are to be etched on the material of interest, and protects the other areas of that material from the action of the etchant. The mask must of course be constructed of a material that is impervious to the etchant.

Appropriate etchants may be characterized as isotropic or anisotropic with respect to the material to be etched. In isotropic etching, material is etched away at the same rate in all directions through the material. The etch rate in isotropic materials does not depend upon the orientation of the mask edge to the etched material. Some single crystal materials, such as silicon, exhibit anisotropic etching in response to certain etchant chemicals. Anisotropic etching, as contrasted with isotropic etching, results in different etch rates depending upon the direction in which the material is being etched. This is a function of the crystalline form of the etched material, and the direction along which its crystal lines are formed.

The differences between anisotropic and isotropic etching of silicon are shown by illustration of a particular example in FIG. 1. In both illustrated cases, silicon material 10 is covered with mask 12, and an etchant chemical is applied. The result in the isotropic example is a roughly cup-shaped isotropic etched area 14. The etched area of silicon material 10 delves beyond the edge of mask 12, which is the result of the equal etching movement in all directions once the etchant is applied. By contrast, the result in the anisotropic example is an anisotropic etched area 16 shaped as an inverted, truncated pyramid. These are only examples, and different shapes may be achieved depending upon the etching agent used and the orientation of mask 12 to the crystalline lines formed in silicon material 10. The anisotropic etch rate is largely dependent upon the orientation of the mask with the crystalline planes within the material. In addition, the final shape of the etched material is also dependent upon the orientation of the mask edge to the crystalline planes within the material. Other possible shapes, also useful for the lensing of optoelectronic devices, include parabolic-shaped structures. Either of these shapes may be created using an anisotropic etchant like potassium hydroxide (KOH), or other hydroxides such as tetramethylammonium hydroxide (TMAH).

It has been recognized by the inventor hereof that this anisotropic etching process may be used in the formation of reflectors for LED die illumination systems. It should be noted that while the preferred embodiment of the invention utilizes KOH as an etchant in silicon to form micro-reflector cavities shaped as inverted, truncated pyramids, the invention is not limited to this particular wafer material, etchant, or etched shape.

The placement of an LED die in material with a reflective cavity formed in the manner as just described according to the preferred embodiment of the invention is illustrated in FIG. 2. Silicon wafer 18 contains cavity 20, which is shaped as an inverted, truncated pyramid formed by KOH anisotropic etching of silicon wafer 18. The interior surface of cavity 20 is metalized with metal layer 21. The purposes of metal layer 21 are to increase the reflective properties of cavity 20, and to provide conductive paths for the electrical interconnection of die 22 within the cavity. The cathode (not shown) of LED die 22 connects with metal layer 21 utilizing a thermally and electrically conductive epoxy such as those manufactured by Epoxy Technology of Billerica, Mass. The metal chosen in the preferred embodiment of the present invention for metal layer 21 is a platinum overlay with a chromium adhesion layer. Other metals that may be used in alternative embodiments for the metalization of cavity 20 with metal layer 21 are aluminum, nickel, and gold. The anode (not shown) of LED die 22 is electrically connected to external control circuitry (not shown) using standard gold wire bonding techniques.

Photons emitted by LED die 22 are illustrated in FIG. 2 by directional arrows 24. LED die 22 produces light exiting at its sides along P-N junction 26. This light is reflected within cavity 20 at metal layer 21 to pass outwardly in a generally cone-shaped area, whose central axis is orthogonal to the plane of LED die 22 and silicon wafer 18.

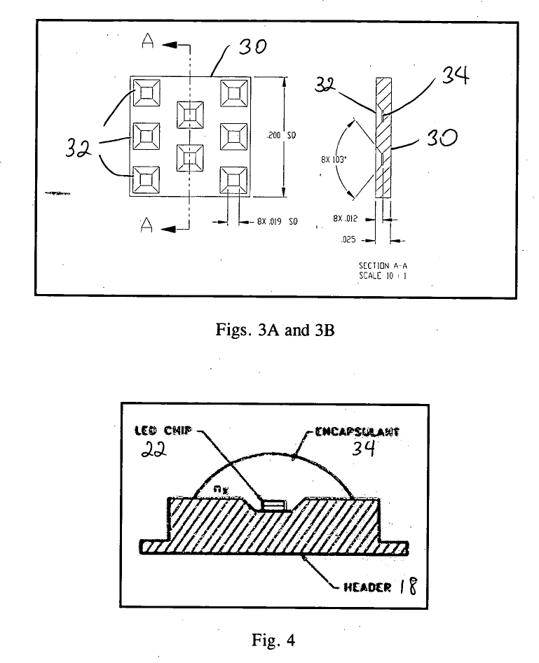

A silicon wafer as used in a preferred embodiment of the invention as part of a practical RGB LED illumination system is illustrated in FIGS. 3A and 3B. Silicon wafer 30 is comprised of eight etched micro-reflector cavities 32 etched into a single wafer into which individual red, green and blue (RGB) chip-on-wire LEDs (not shown) may be arranged as densely populated RGB clusters. The micro-reflector cavities 32 are arranged on silicon wafer 30 in a manner to promote homogenization of light exiting from all cavities 32 comprising the array. The use of RGB clusters including multiple micro-reflector cavities 32 permits light of various colors and intensities, including white light, to be produced from a single lighting module using one silicon wafer 30. The light intensity of each color of LED within the RGB cluster may be individually controllable, allowing the control of both light intensity and hue for each wafer 30. In the preferred embodiment, the micro-cavities 32 are arranged in a 3-2-3 pattern covering a square area on silicon wafer 30 of about 0.200 inches per side, with the bottom of each of the inverted pyramids of micro-cavities 32 being a square of approximately 0.019 inches per side. Silicon wafer 30 in the preferred embodiment may be of a thickness of approximately 0.025 inches, with the depth of micro-cavities 32 in silicon wafer reaching to approximately 0.012 inches.

Each wafer 30 is thermally bonded to a thermally conductive heat sink 34 (not shown). In the preferred embodiment, heat sink 34 is simply the outside case of an assembled lighting fixture, thereby allowing heat sink 34 to perform two functions simultaneously, and thus reduce the cost of the overall lighting system. Heat sink 34 is bonded to wafer 30 using thermally conductive epoxies such as those manufactured by Epoxy Technologies. Great care must be exercised in the selection of the material of which heat sink 34 is formed and the bonding process to ensure the efficiency of heat sink 34, as well as to minimize the thermal resistance between LED die 22 and wafer 30, and wafer 30 and heat sink 34.

Turning now to FIG. 4, LED die 22 on wafer 30 is, in a preferred embodiment of the invention, enclosed in an encapsulant material 34. This encapsulant material is preferably a high refractive index optical gel such as those manufactured by Lightspan, LLC of Wareham, Mass. Encapsulant material 34 serves to increase the efficiency of the production of light in the illumination system comprising wafer 30 and LED die 22.

The light output efficiency of an LED is in part determined by the efficiency with which light can pass from the external surface of an LED die to the external medium, usually an encapsulation material such as an epoxy or a gel. A soft encapsulant such as a gel or soft thermoset, instead of an epoxy, is usually required for high brightness LEDs (HBLEDs) in order to provide the mechanical strain relief needed for the larger temperature swings encountered in these devices. The light extraction from the LED die at the interface is limited by the angle of total internal reflection at the interface, given by the formula:

θc =arc sin{n_{gel}/n_{die}}

where n_{die} is the index of refraction of the LED die 22, and n_{gel} is the index of refraction of the material surrounding the chip (in the case of this example but not in the preferred embodiment of the present invention, that material is air). In a flip-chip design, the encapsulation contacts the LED substrate 22 which itself functions as an emission window; thus, in the flip-chip case n_{die} is the value of refractive index for the substrate material. In an LED where the photon emission within the die is isotropic, emitted light rays arrive at the die surface from all possible angles of incidence. Only those light rays with an angle of incidence θ less than the critical angle θc will be transmitted out of the die 22 and into the adjacent encapsulation gel. The remaining rays are internally reflected. Since the rays can reach the surface from any azimuthal angle, the escaping rays populate an extraction cone of 360° in azimuth and from 0 to θc in angle of incidence. Integrating the ray population over this cone gives a figure of merit for the approximate scaling of light extraction with θc,

XFOM={1−cos θc}.

This equation can be used to estimate the relative improvement in light output obtained by changes in the value of n_{gel} for various values of n_{die}. Note that compared to the use of no encapsulant at all, the higher index encapsulants provide an increase in light extraction of a factor of 2.5× to 3×.

Taking the example of Lightspan™ optical gel with an optical index of 1.6 and a gallium nitride LED die with a refractive index of 2.5, and substituting these values into the critical angle equation, yields a critical angle of approximately 40°, significantly improved over the critical value of 24° where the material in contact with LED die 22 is air. This increase in critical angle provides an increase in light extraction of about 2.8×. Thus to reduce the loss of optical efficiency due to these reflections and therefore increasing the useful power output of each wafer 30 and each of its associated LED dies 22, each die 22 is encapsulated with encapsulant 34. The preferable form of encapsulant 34 is hemispherical, thus acting as a lens to further focus the light from LED dies 22. Encapsulant 34 also acts as a protective package for the LED die 22 within the system.

The present invention has been described with reference to certain preferred and alternative embodiments that are intended to be exemplary only and not limiting to the full scope of the present invention as set forth in the appended claims.

What is claimed is:

1. An LED light system, comprising:
(a) a wafer, said wafer comprising a micro-reflector cavity at the surface of said wafer; and
(c) an LED die mounted within said reflector cavity.

2. The LED light system of claim 1, wherein said wafer is formed of a semiconductor material.

3. The LED light system of claim 2, wherein said reflector cavity is coated with a conducting material, said LED die comprises an anode and a cathode, and said conducting material contacts one of said anode and said cathode.

4. The LED light module of claim 3, wherein said reflector cavity is shaped as an inverted, truncated pyramid.

5. The LED light module of claim 3, wherein said reflector cavity comprises opposing sides, and an angle formed between said opposing sides is about 71°.

6. The LED light module of claim 3, wherein said LED die comprises a red LED, a green LED, and a blue LED.

7. The LED light module of claim 6, wherein said wafer comprises a plurality of micro-reflector cavities, said micro-reflector cavities formed in a cluster on said wafer.

8. The LED light module of claim 3, further comprising an encapsulant that encases said LED die.

9. The LED light module of claim 8, wherein said encapsulant is a high refractive index optical gel.

10. A method of constructing a light system comprising a semiconductor wafer and an LED die, comprising the steps of:
(a) etching the semiconductor wafer to form a micro-reflector cavity; and
(b) mounting an LED die within the micro-reflector cavity.

11. The method of claim 10, further comprising the steps of coating the micro-reflector cavity with a conducting material, and connecting one of a cathode and anode attached to the LED die to the conducting material.

12. The method of claim 11, wherein said step of etching the semiconductor wafer is performed with an etching agent that acts in an anisotropic manner with respect to the semiconductor material.

13. The method of claim 12, wherein the semiconductor material is silicon, and the etchant material is a hydroxide.

14. The method of claim 13, wherein said etchant material is potassium hydroxide.

15. The method of claim 11, wherein the micro-reflector cavity formed in said etching step is shaped as an inverted, truncated pyramid.

16. The method of claim 11, wherein the reflector cavity formed in said etching step has opposing sides, and the angle formed between the opposing sides is about 71°.

17. The method of claim 11, wherein the LED die comprises a red LED, a green LED, and a blue LED.

18. The method of claim 17, wherein said etching step comprises the formation of a plurality of micro-reflector cavities such that the plurality of micro-reflector cavities form a cluster on said wafer.

19. The method of claim 12, further comprising the step of encasing the LED die with an encapsulant.

20. The method of claim 19, wherein said encapsulant is a high refractive index optical gel.
